(19) United States
(12) Patent Application Publication
(10) Pub. No.: US 2012/0154583 A1
(43) Pub. Date: Jun. 21, 2012

(54) METHOD AND SYSTEM FOR MONITORING THE ACCESSIBILITY OF AN EMERGENCY EXIT

(75) Inventors: Stefan Lundberg, Lund (SE); Carl-Axel Alm, Lund (SE)

(73) Assignee: AXIS AB, Lund (SE)

(21) Appl. No.: 13/330,107

(22) Filed: Dec. 19, 2011

Related U.S. Application Data
(60) Provisional application No. 61/425,014, filed on Dec. 20, 2010.

(30) Foreign Application Priority Data
Dec. 20, 2010 (EP) 10195988.0

(51) Int. Cl. H04N 7/18

(52) U.S. Cl. 348/143; 348/E07.085

(57) ABSTRACT

A system and device perform a method for monitoring the accessibility of an emergency exit, which includes illuminating an area in front of the emergency exit by emitting light, detecting reflected light from the illuminated area using an image sensor, calculating a plurality of distances based on the detected reflected light for discrete positions in the image sensor, comparing the each of the plurality of distances with a predetermined distance, and generating an alarm signal if the comparing indicates a substantial difference in distance in at least one position in the image sensor.

### CROSS REFERENCE TO RELATED APPLICATIONS

This application claims the benefit of U.S. provisional application No. 61/425,014 filed on Dec. 20, 2010 and European application no. 10195988.0 filed on Dec. 20, 2010 which are incorporated by reference as if fully set forth.

### FIELD OF THE INVENTION

The present invention relates to a method and system for monitoring the accessibility of an emergency exit such as a door or window by monitoring the emergency exit.

### BACKGROUND OF THE INVENTION

Remote monitoring of emergency exits is interesting from a security point of view and interesting to companies that are responsible for having properly functioning emergency exits. It is thus desirable to know if the emergency exit is blocked or free from blocking obstacles.

Remote monitoring of emergency exits is normally achieved by the use of an alarm unit that sends an alarm to an alarm center if the door or window is opened. A problem with this configuration is that the emergency door or window may be blocked by for example an obstacle. An alarm is in that case not being sent to the alarm centre even if the accessibility of the emergency door or window is blocked by an obstacle.

One approach is to use alarm units such as movement detectors based on for example infrared technology that are capable of detecting if someone is moving around in the vicinity of the emergency exit. However, movement detectors cannot be used for all cases, since the movement detector cannot detect a physical obstacle blocking the emergency exit.

In some applications it is desirable to be able to visualize the emergency exit to see if an obstacle and what kind of obstacle that may be blocking the emergency exit. In these applications, video capturing cameras may be used. However, remote monitoring using video capturing cameras requires proper mounting and are usually much more costly than movement detectors. In addition to that, someone needs to monitor the video.

### SUMMARY OF THE INVENTION

A method, apparatus and system to improve remote monitoring of the accessibility of emergency exits are described. In particular, according to a first embodiment, a method for monitoring the accessibility of an emergency exit is disclosed. The method comprises illuminating an area in front of the emergency exit by emitting light. The reflected light from the illuminated area is detected using an image sensor. A plurality of distances is calculated based on the detected reflected light for discrete positions in the image sensor. Each of the plurality of distances is compared with a predetermined distance, and an alarm signal is generated if the comparison indicates a substantial difference in distance in at least one position in the image sensor.

The term substantial difference in distance should be understood as a distance which should be at most in the same order of magnitude as the physical size of a possible obstacle blocking the emergency exit. According to a non-limiting example the substantial difference in distance is in the order of decimeters. Other substantial differences in distance is possible to use; it depends on the set-up and the required precision in the measurements.

With the method for monitoring the accessibility of the emergency exit, it is possible to see if the emergency exit is open or if any obstacle is blocking the exit. By illuminating an area in front of the exit and measuring the reflected light, it is possible to determine if the obstacle is present long enough or if the obstacle is big enough so that the obstacle is blocking the emergency exit.

The method, comprising illuminating an area, may further comprise emitting light from a position above the emergency exit. The possibility of mounting a light emitting device above the emergency exit makes it possible to mount the light emitting device on all kinds of emergency exits since there in most cases is an available place where the light emitting device can be mounted.

The method may further comprise emitting light from a device comprising the image sensor. Mounting the illuminator emitting the modulated light as well as the image sensor in the same housing may also facilitate the operation of the method. It is also cheaper to manufacture such a device rather than manufacturing two devices.

The emergency exit according to the method may be an emergency exit door. Illuminating an area in front of the emergency exit may further include illuminating the emergency exit door.

An alarm may be generated according to the method if the plurality of registered distances indicates that the emergency exit door is open. If the method is applied to an emergency exit door it is possible to use this method to determine if the door is open or closed by measuring reflected light or absence of reflected light from the door.

The act of generating an alarm signal according to the method may further require that the substantial difference is present during at least a predetermined time before the alarm signal is generated. According to a non-limiting example, the predetermined time according to the method may be 1-30 minutes. According to another non-limiting example, the predetermined time according to the method may be 5-15 minutes. The skilled person realized that other predetermined time periods may be used; it all depends on the requirements of the installation.

A benefit of waiting for a predetermined time is that temporary blocking of the emergency exit does not trigger the alarm. For example, if a person is passing by the emergency exit, an alarm would normally be triggered if infrared alarm detector were in use. However, having the setup in which the monitoring device is waiting for an obstacle to be present for a predetermined time before sending an alarm, an alarm is not triggered for the event of someone passing by. It should be noted, however, that there is still a possibility to have an alarm triggered even for temporary blocking of the emergency exit. Moreover, it should also be noted that the substantial difference may be present during both shorter and longer time periods than indicated in the non-limiting examples above before the alarm signal is generated.

The image sensor according to the method may further include an array of light sensitive pixels. An advantage with an array of light sensitive pixels is that the resolution is increased.

The emitted light according to the method may be a modulated light. The modulated light may be a frequency modulated light. The reason for modulating the light is to be able to distinguish the reflected light originating from the light emitting device from other ambient light sources.

The act of calculating a plurality of distances according to the method may further require measuring a travel time for the reflected light at discrete positions in the image sensor. By measuring travel times for the reflected light at discrete positions it is possible to determine where a specific point of the object is positioned in space. This information is then used to determine the shape and size of the object.

According to another embodiment the image sensor is a time-of-flight, TOF, type image sensor. Unlike a conventional image sensor, a TOF image sensor delivers not only an intensity image but also a range map that contains a distance measurement at each pixel, obtained by measuring the time required by light to reach an object and return to the camera (time-of-flight principle).

The emitted light according to the method may be coherent light. The coherent light may be emitted through a diffuser being arranged to provide a speckle pattern. The diffuser may be, for example, a diffractive optical element or an astigmatic optical element. By measuring the variations in a speckle pattern, it is possible to determine the distance to different points of a monitored area. In addition, using coherent light may allow the camera to be less sensitive to ambient light by for example using narrow filters that are matched to the coherent light.

According to an embodiment of the present invention, a monitoring device comprises an image sensor. The monitoring device performs the method of monitoring the accessibility of an emergency exit and being arranged above the emergency exit.

According to an embodiment of the present invention, a monitoring system comprises an illuminator arranged to emit light in an area in front of the emergency exit. The monitoring system further comprises an image sensor arranged to detect reflected light from the illuminated area. Processing means are arranged to calculate a plurality of distances based on detected reflected light for discrete positions in the image sensor. The plurality of distances are compared in relation to at least one predetermined distance, and an alarm generator is arranged to generate an alarm signal if the comparison results in a substantial difference in distance in at least one position in the image sensor.

The monitoring system allows for an improved arrangement for detecting obstacles blocking and emergency exit, such as a door or window. The arrangement is also capable of detecting whether the door or window is opened or closed.

According to another embodiment, the monitoring system further comprises an I/O port configured to send the alarm signal via a network.

Emergency exits may be positioned at places where an alarm cannot be heard or seen by anyone and thus may need monitoring from a remotely positioned place. The transmitter sends alarm signals through the network to a remote place.

According to an embodiment, the illuminator and the image sensor is arranged in a monitoring device. Having both the illuminator and the image sensor in the same device facilitates mounting of the device since there is only one device to be mounted. In addition, cheaper manufacturing costs may be achieved.

### BRIEF DESCRIPTION OF THE DRAWINGS

This and other aspects of the present invention will now be described in more detail, with reference to appended drawings showing embodiments of the invention. The drawings should not be considered limiting the invention to the specific embodiment. Instead the drawings are used for explaining and understanding the invention.

FIG. 1A is a schematic view of a monitoring device, according to a first embodiment of the invention.

FIG. 1B is a schematic flow chart showing the method of using the monitoring device according to the first embodiment of the invention.

FIG. 2A is a schematic view of a monitoring device, according to a second embodiment of the invention.

FIG. 2B is a schematic flow chart showing the method of using the monitoring device according to the second embodiment of the invention.

FIGS. 3a-c are a front view, a side view and a top view, respectively, of a monitoring system mounted above an emergency exit, according to one embodiment of the invention.

FIG. 4 is a perspective view of an emergency exit with an obstacle.

FIG. 5 is a perspective view of an emergency exit in which the emergency exit is opened.

### DETAILED DESCRIPTION

The present invention relates monitoring of an emergency exit in order to detect if an obstacle is blocking the emergency exit.

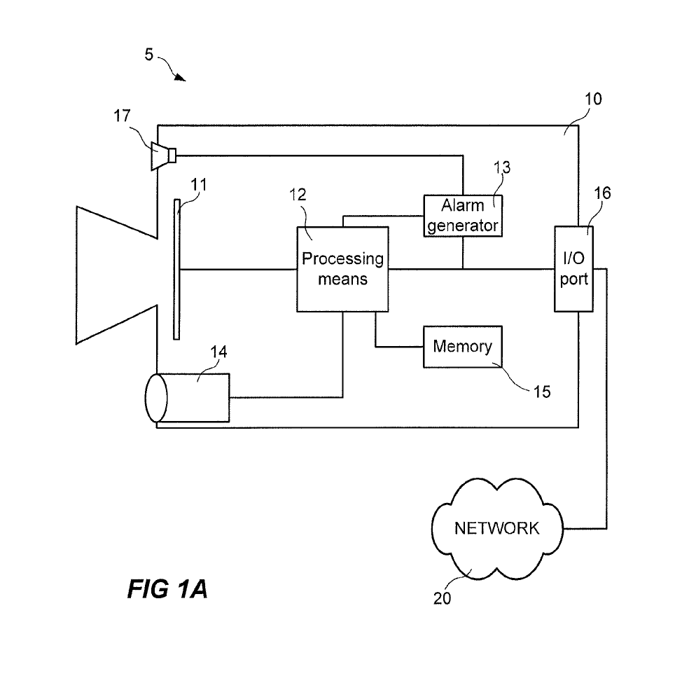

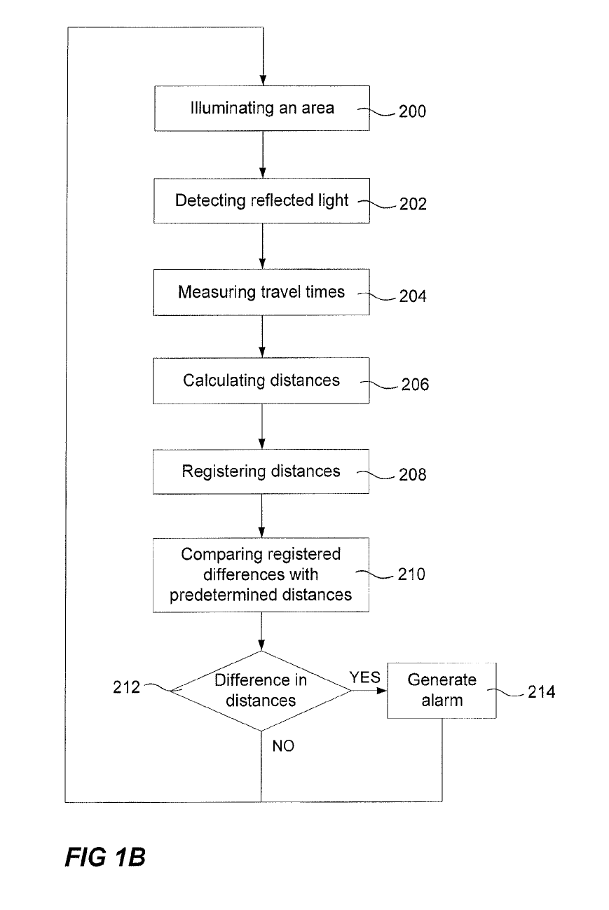

A monitoring device 5 according to one embodiment of the present invention is shown in FIG. 1A. The monitoring device 5 comprises a housing 10, an illuminator 14, an image sensor 11, processing means 12, a memory 15, an alarm generator 13, an audio signal generator 13 and an I/O-port 16. The image sensor 11, the illuminator 14, the memory 15, the alarm generator 13 and the I/O-port 16 are all connected to the processing means 12. The monitoring device is connected to a network 20 via the I/O-port 16. The alarm generator 13 is connected to an audio signal generator 17.

The illuminator 14 is used to emit light and illuminate a predetermined area in front of an emergency exit. The illuminator 14 may also illuminate an area that includes the emergency exit. The emergency exit may for example include a door or a window. The illuminator 14 is arranged either as a separate unit apart from the monitoring device 5 or as in the shown embodiment enclosed within the monitoring device 5.

The illuminator 14 may be, for example, a light emitting diode (LED) or a laser. The illuminator 14 may be operated in a pulsed manner.

The light may be modulated with a frequency of 20-40 MHz and emitted at a wavelength of 855-947 nm. It should be noted, however, that other frequencies or wavelengths may be used. In addition, it is possible to use various kinds of modulation techniques. One purpose of modulating the light and/or using different wavelengths is to be able to distinguish a first monitoring device from a second monitoring device in the case where both cameras are positioned in a way that they may disturb each other. The disturbance may originate from when the illuminator 14, being connected to a first monitoring device, illuminates an area, in which area the reflected light is detected by the image sensor of a second monitoring device.

The image sensor 11 is arranged to capture the reflected light originating from the illuminator 14 and to retrieve information from the reflected light. According to the embodiment described in connection to FIG. 1A, the image sensor 11 is a time of flight type of sensor, although other sensor types may be used. A lens (not shown) may gather the reflected light and image the environment onto the image sensor 11. The monitoring device 5 may also copmprise an optical band pass filter (not shown) which only passes the light with the same wavelength as emitted by the illuminator 14. This helps suppress background light. The image sensor 11 is connected to the processing means 12 to which the image sensor 11 sends the captured information. The image sensor 11 could have a high sensitivity to be able to detect small intensities in the reflected light. The image sensor 11 may include an array of light sensitive pixels, for example a matrix of 200 by 200 pixels. The light sensitive pixels may as an alternative be arranged in a circular pattern. For each pixel the time the light has taken to travel from the illuminator 14 to the object reflecting the light and back is measured.

The processing means 12 is connected to the image sensor 11, the illuminator 14, the alarm generator 13, the memory 15 and the I/O-port 16. The processing means 12 is arranged to control the illuminator 14 and further arranged to receive information from the image sensor 11 about the reflected light received by the image sensor 11. The processing means 12 is arranged to calculate a travel time for the reflected light at discrete positions in the image sensor 11 and translate the travel time into a distance. Each distance is then compared with a corresponding predetermined distance.

The processing means 12 is further connected to a memory 15 used to store information received by the image sensor 11. The processing means 12 is also arranged to send a signal to the alarm generator 13 and/or the I/O-port 16 to indicate if an obstacle is present or not.

The processing means 12 may further be arranged for other types of analyses to be performed on the information received from the images sensor 11. This could for example be a tracking function useful for tracking and identifying obstacles within a part of the illuminated area. It should be noted that processing means 12 may consist of separate processing means for calculating travel time and for tracking, or may be executed in the same processing means. The processing means 12 may be implemented as a processor or non-transitory computer readable medium having an executable code that when executed, performs the calculating, analyses, and tracking steps for monitoring an emergency exit as described herein.

The alarm generator 13 is connected to an audio signal generator 17, e.g., a speaker, and the I/O-port 16. The alarm generator 13 is arranged to send a signal to the signal generator 17 and/or the I/O-port 16. If the monitoring device 5 is required to generate an audio signal if an obstacle is present, the signal is sent to the audio signal generator 17. Alternatively, if no audio signal is required, a signal indicating an obstacle being present is sent to the network 20 via the I/O-port 16. A combination of audio signal and signaling to the network 20 is also possible.

As shown in FIG. 1A, the I/O-port 16 is used to connect the monitoring device 5 to a network 20. The I/O-port 16 may further comprise a transmitter arranged to send alarm signals to the network 20.

As depicted in FIG. 1B, the monitoring device 5 is used in the following manner in order to detect if an obstacle is blocking the emergency exit or not.

An area to be monitored is illuminated 200 by the illuminator 14 emitting modulated light. The light is reflected after reaching the illuminated area. Depending on the surface of the illuminated area and/or if there is an obstacle present, the light is reflected in various directions.

The image sensor 11 detects 202 the reflected light. A majority of the light might not be reflected back into the image sensor 11. However, the part of the light that is detected should be sufficient to make an analysis on (i.e., the image sensor 11 should be capable of detecting the modulation format and capable of retrieving information from the reflected light). Each pixel of the image sensor 11 may detect reflected light independently of each other.

A travel time for each pixel is then measured 204. The measurement is based on the reflected light being compared with the light emitted from the illuminator 14. The modulation format could be used to determine how long time it takes for the light to travel from the illuminator 14 and back to the image sensor 11. For example by modulating the light emitted from the illuminator 14 with a known pattern and thereafter measure the time it takes for the known pattern to be detected by the image sensor 11.

The measured travel times are used to calculate travel distances 206 for each pixel of the image sensor 11. The travel distances are registered 208 and stored in the memory 15. The registered distances are then compared with a respective predetermined distance 210. The respective predetermined distances may be set during mounting or during a calibration of the monitoring device 5. For example, the predetermined distance may be set after mounting the monitoring device 5 by registering these distances as predetermined distances.

A check is made to control if there is a difference between the registered distance and the predetermined distance 212. If there is a difference between the registered distance and the predetermined distance and if this difference is substantially large, a signal is sent 214 to the alarm generator 13. The difference between the registered distance and the predetermined distance being substantially large may be, for example, a distance which should be in the same order of magnitude as the physical size of a possible obstacle blocking the emergency exit. According to a non-limiting example, the substantially large difference in distance is 5 cm to 5 dm. The alarm generator 13 may then, according to its setting, send the alarm to the audio signal generator 17 and/or the I/O-port 16.

If there is no difference in distance between any of the calculated distances and a predetermined distance, then the process is repeated again by illuminating the area to be monitored. Normally it is sufficient if the process is repeated every minute. However, the process may also be repeated as often as every second or even more frequently. According to one embodiment, the process is repeated for every frame captured by the image sensor 11, which captures 10 to 60 frames per second.

Even if there is a difference between the distances, which means that there is an obstacle present within the illuminated area, there might be a need to combine this comparison with a time interval. For example, if an obstacle is present during one or a few seconds, there may not be a need to generate an alarm. Setting a time, during which time there should be a difference in distances, before generating an alarm, avoids alarms to be triggered for temporary obstacles. A predetermined time interval may be in the order of 5-15 minutes for an emergency exit, although other shorter as well as longer time intervals are possible.

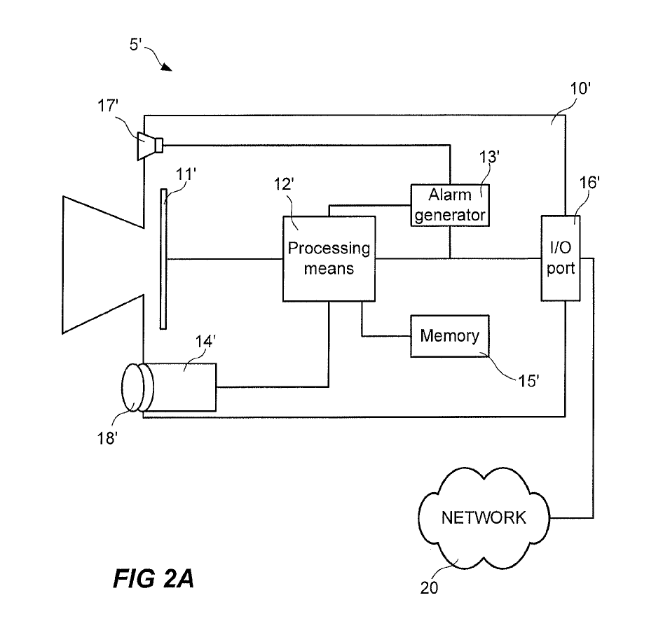

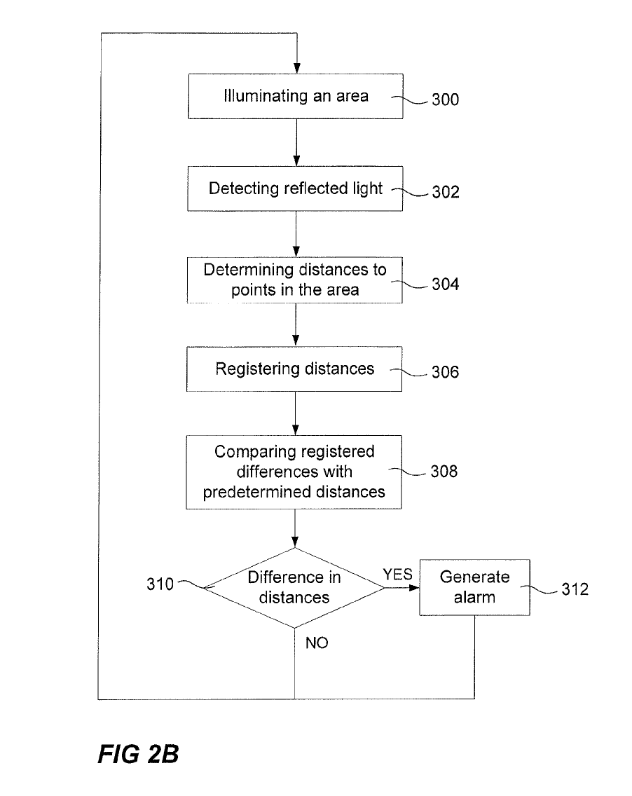

An alternative embodiment of a monitoring device 5′ according to the present invention is shown in FIG. 2A. Moreover, FIG. 2B is a schematic flow chart showing the method of using the monitoring device 5′ according to this alternative embodiment of the invention. According to this embodiment a speckle imaging device is incorporated into the monitoring device 5′ in order to make a 3D mapping of the area in front of the emergency exit.

According to this alternative embodiment the monitoring device 5′ comprises a housing 10′, an illuminator 14′, a diffuser 18′, an image sensor 11′, a processing means 12′, a memory 15′, an alarm generator 13′, an audio signal generator 13′ and an I/O-port 16′. The image sensor 11′, the illuminator 14′, the memory 15′, the alarm generator 13′ and the I/O-port 16′ are all connected to the processing means 12′. The monitoring device is connected to the network 20 via the I/O-port 16′. The alarm generator 13′ is connected to an audio signal generator 17′.

The illuminator 14′ is used to emit light and illuminate 300 a predetermined area in front of the emergency exit. The illuminator 14′ may also illuminate an area that includes the emergency exit. The emergency exit may for example be a door or a window. The illuminator 14′ is arranged either as a separate unit apart from the monitoring device 5′ or as in the shown embodiment enclosed within the monitoring device 5′.

The illuminator 14′ may be, for example, a light emitting diode (LED) or a laser. The illuminator 14′ is arranged to emit coherent light. The coherent light is emitted through the diffuser 18′ for providing a speckle pattern on the area to be monitored. At least some of the light from the speckle pattern is reflected from the area to be monitored back to the image sensor 11′. The term light regarding this embodiment refers to any sort of optical radiation, including infrared and ultraviolet, as well as visible light.

It is possible to use different wavelengths for different monitoring devices. One purpose using different wavelengths is to be able to distinguish a first monitoring device from a second monitoring device in the case where both cameras are positioned in a way that they may disturb each other. The disturbance may originate from when the illuminator 14′, being connected to a first monitoring device, illuminates an area, in which area the reflected light is detected by the image sensor of a second monitoring device.

The beam of light emitted from the illuminator 14′ is passing through the diffuser 18′ and thus generates a diverging beam. As a result a speckle pattern is produced. As a result, the speckle pattern is projected onto the monitored area.

A lens (not shown) is arranged to gather the reflected light and image the environment onto the image sensor 11′. The monitoring device 5′ may also copmprise an optical band pass filter (not shown) which only passes the light with the same wavelength as emitted by the illuminator 14′. This helps suppress background light.

The image sensor 11′ is arranged to capture an image of the speckle pattern that is projected onto the monitored area. Thus, the image sensor 11′ is arranged to capture 302 the reflected light from the projected speckle pattern. The image sensor 11′ could have a high sensitivity to be able to detect small intensities in the reflected light. Typically the image sensor 11′ includes a rectilinear array of light sensitive pixels, for example a matrix of 200 by 200 pixels. The image sensor may be, for example, a CCD or CMOS-based image sensor array.

The distance to points in the monitored area, as well as shifts in the distance to the points in the monitored area over time, may be determined 304 by measuring shifts in the speckles in the images captured by the image sensor 11′ relative to a reference image taken at a known distance.

The image sensor 11′ is connected to the processing means 12′ to which the image sensor 11′ sends the captured information. The processing means 12′ is arranged to control the illuminator 14′ and further arranged to receive information from the image sensor 11′ about the reflected speckle pattern received by the image sensor 11′. The processing means 12′ is arranged to calculate distances to points in the monitored area based on the captured speckle pattern.

The distances to the points in the monitored area are registered 306, possibly by storing them in the memory 15′.

The registered distances are then compared 308 with a respective predetermined distance. The respective predetermined distances may be set during mounting or during a calibration of the monitoring device 5′. For example, the predetermined distance may be set after mounting the monitoring device 5′ by registering these distances as predetermined distances.

A check 310 is made to control if there is a difference between the registered distance and the predetermined distance. If there is a difference between the registered distance and the predetermined distance and if this difference is substantially large, a signal is sent 312 to the alarm generator 13. The difference between the registered distance and the predetermined distance being substantially large may be, for example, a distance which should be in the same order of magnitude as the physical size of a possible obstacle blocking the emergency exit. According to an embodiment, the substantially large difference in distance is 5 cm to 5 dm. The alarm generator 13 may then according to its setting send the alarm to the audio signal generator 17 and/or the I/O-port 16.

The alarm generator 13′ is connected to an audio signal generator 17′, e.g., a speaker, and the I/O-port 16′. The alarm generator 13′ is arranged to send a signal to the signal generator 17′ and/or the I/O-port 16′. If the monitoring device 5′ is required to generate an audio signal if an obstacle is present, the signal is sent to the audio signal generator 17′. Alternatively, if no audio signal is required, a signal indicating an obstacle being present is sent to the network 20 via the I/O-port 16′. A combination of audio signal and signaling to the network 20 is also possible.

As shown in FIG. 2A, the I/O-port 16′ is used to connect the monitoring device 5′ to a network 20. The I/O-port 16′ may further comprise a transmitter arranged to send alarm signals to the network 20.

If there is no difference in distance between the calculated distances and the predetermined distances, then the process is repeated again by illuminating the area to be monitored. Normally it is sufficient if the process is repeated every minute. However, the process may also be repeated as often as every second or even more often. According to one embodiment the process is repeated for every frame captured by the image sensor 11′, which captures 10 to 60 frames per second.

Even if there is a difference between the distances, which means that there is an obstacle present within the illuminated area, there might be a need to combine this comparison with a time interval. For example, if an obstacle is present during one or a few seconds, there may not be a need to generate an alarm. Setting a time, during which time there should be a difference in distances, before generating an alarm, avoids alarms to be triggered for temporary obstacles. A predetermined time interval may be in the order of 5-15 minutes for an emergency exit, although other shorter as well as longer time intervals are possible.

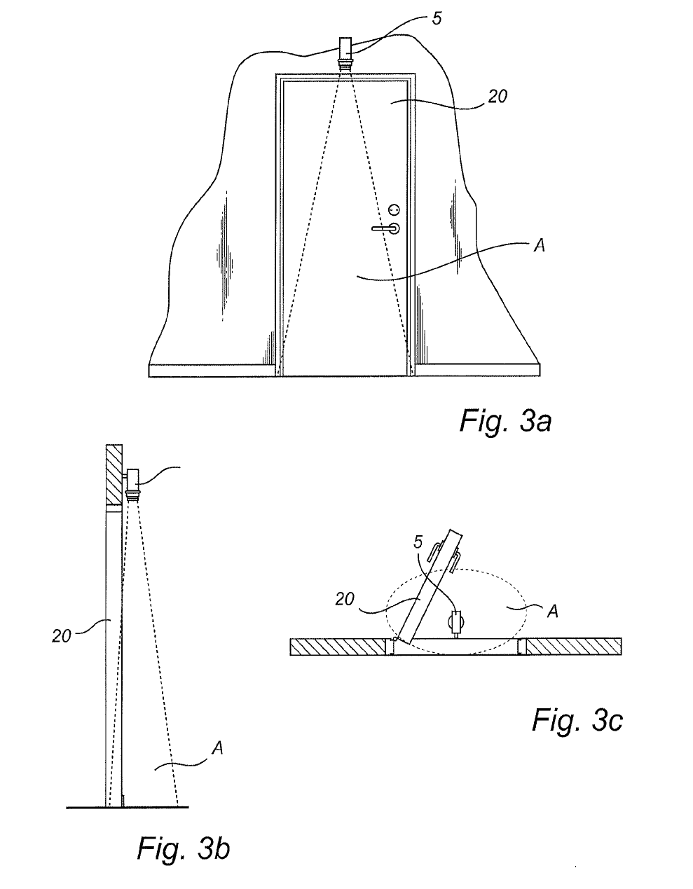

FIGS. 3a, 3b, 3c shows a front view, a side view and a top view, respectively, of a monitoring device 5 mounted above an emergency exit door 20, according to one embodiment of the invention.

The illuminator of the monitoring device 5 emits light in a way such that it illuminates an area A in front of the emergency exit door 20. It is then possible to detect if for example the emergency exit door 20 is opened as illustrated in FIG. 3c.

It should be realized that it is possible to mount the monitoring device 5 on other positions close to the emergency exit door 20. For example, the monitoring device 5 may be positioned on the side of the emergency exit door 20 or even on the emergency exit door 20.

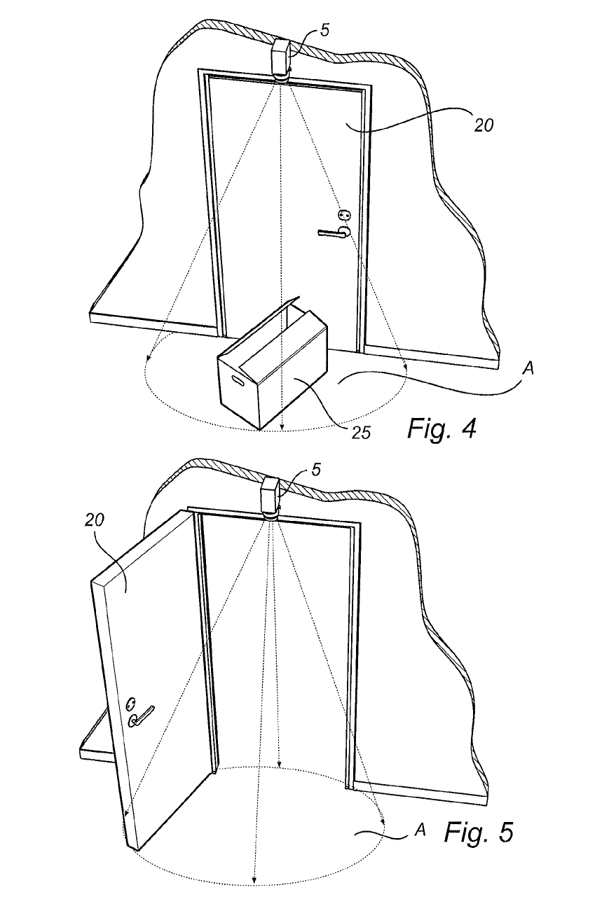

FIG. 4 shows a perspective view of an emergency exit door 20 with an obstacle 25 blocking the emergency exit door 20. Reflected light from the obstacle 25 is detected and compared with a predetermined setting. The predetermined setting may be the case when there is no obstacle present. Since there is a difference during the comparison, an alarm is triggered.

FIG. 5 shows a perspective view of an emergency exit in which the emergency exit door 20 is opened. In this case the presence of reflected light from the emergency exit door 20 is detected by the monitoring device 5 and an alarm is triggered.

An alternative of the monitoring system may further comprise processing means, such as a processor, arranged to track identified objects. By tracking identified objects, it is possible to determine a part of the monitored area that is to be monitored. Objects outside that specific area are still monitored but may not trigger an alarm.

The person skilled in the art realizes that the present invention by no means is limited to the preferred embodiments described above. For example, the respective predetermined distances may be set as a predetermined value. That is, when setting up the monitoring device for monitoring an emergency exit a predetermined value used as a predetermined distance may be set in the monitoring device. Thus, many modifications and variations are possible within the scope of the appended claims.

What is claimed is:

1. A method for monitoring the accessibility of an emergency exit, comprising:
illuminating an area in front of the emergency exit by emitting light;
detecting reflected light from the illuminated area using an image sensor;
calculating a plurality of distances based on the detected reflected light for discrete positions in the image sensor;
comparing each of the plurality of distances with a predetermined distance; and
generating an alarm signal if the comparing indicates a substantial difference in distance in at least one position in the image sensor.

2. The method according to claim 1, wherein illuminating an area includes emitting light from a position above the emergency exit.

3. The method according to claim 1, wherein the emitted light is emitted from a device comprising the image sensor.

4. The method according to claim 1, wherein the emergency exit is an emergency exit door and wherein illuminating an area in front of the emergency exit further includes illuminating the emergency exit door.

5. The method according to claim 1, wherein the act of generating an alarm signal further requires that the substantial difference is present during at least a predetermined time before the alarm signal is generated.

6. The method according to claim 5, wherein the predetermined time is 5-15 minutes.

7. The method according to claim 1, wherein the image sensor further includes an array of light sensitive pixels.

8. The method according to claim 1, wherein the emitted light is modulated.

9. The method according to claim 1, wherein the calculating a plurality of distances is based on measuring a travel time for the reflected light at discrete positions in the image sensor.

10. The method according to claim 1, wherein the emitted light is coherent light, and the coherent light is emitted through a diffuser arranged to provide a speckle pattern.

11. A monitoring device comprising an image sensor, the monitoring device configured to perform the method according to claim 1.

12. The monitoring device according to claim 11, wherein the image sensor is a time-of-flight type image sensor.

13. A monitoring system comprising:
an illuminator arranged to emit light in an illuminated area in front of an emergency exit;
an image sensor arranged to detect reflected light from the illuminated area;
a processor arranged to calculate a plurality of distances based on the detected reflected light for discrete positions in the image sensor and to compare each of the plurality of distances with a predetermined distance; and
an alarm generator arranged to generate an alarm signal if the comparing results in a substantial difference in distance in at least one discrete position in the image sensor.

14. The monitoring system according to claim 13, further comprising an I/O port configured to send the alarm signal via a network.

15. The monitoring system according to claim 13, wherein the illuminator and the image sensor are arranged in a monitoring device.
